(19) United States
(12) Patent Application Publication
(10) Pub. No.: US 2013/0050518 A1
(43) Pub. Date: Feb. 28, 2013

(54) INFORMATION PROCESSING APPARATUS, INFORMATION PROCESSING SYSTEM, AND INFORMATION PROCESSING METHOD

(71) Applicants: Tomoaki TAKEMURA, Tokyo (JP); Shinya Masunaga, Tokyo (JP); Nobuhiro Ozu, Tokyo (JP)

(72) Inventors: Tomoaki TAKEMURA, Tokyo (JP); Shinya Masunaga, Tokyo (JP); Nobuhiro Ozu, Tokyo (JP)

(21) Appl. No.: 13/586,209

(22) Filed: Aug. 15, 2012

(30) Foreign Application Priority Data
Aug. 25, 2011 (JP) 2011-184001

(51) Int. Cl. H04N 5/232

(52) U.S. Cl. 348/211.99; 348/E05.042

(57) ABSTRACT

An information processing apparatus includes: an image receiving unit receiving an image series from a remote control apparatus, the remote control apparatus including a camera unit enabling continuous-shooting, the remote control apparatus being capable of sending the image series to an information processing apparatus via a wireless medium, the image series being obtained by continuous-shooting by the camera unit; a display unit having a display screen; a display controller displaying the received image series on the display screen in series; an image storing unit selecting, in response to a first control signal sent from the remote control apparatus via a wireless medium, a store-target image from the displayed image series, and storing the store-target image; and a content obtaining unit obtaining display-dedicated content. The display controller simultaneously displays the obtained display-dedicated content and the received image series on the display screen of the display unit.

### BACKGROUND

The present disclosure relates to an information processing apparatus, an information processing system, and an information processing method. Specifically, the present disclosure relates to an information processing apparatus such as a television receiver controlled by radio signals from a remote control apparatus, an information processing system including the information processing apparatus and the remote control apparatus, and an information processing method.

In the field of remote control apparatuses for remote-controlling an information processing apparatus such as a television receiver, infrared remote controls using infrared communications are the mainstream. However, an infrared ray from the infrared remote control has high directivity. Because of this, it is necessary for a user to direct an infrared light emitting section of the remote control toward a control-target apparatus. To the contrary, a radio wave has relatively low directivity. In view of this, recently, RF (Radio frequency) remote controls using high-frequency radio waves have been developed and are becoming the mainstream. Further, some organizations attempt to standardize the standard of RF remote controls.

For example, ZigBee (registered trademark) is the standard of the specification of the network layer, the security layer, and the application layer. ZigBee (registered trademark) is in conformity with the near field communication standard IEEE (registered trademark) (Institute of Electrical and Electronics Engineers) 802.15.4, and is a higher-level system of IEEE (registered trademark) 802.15.4. Further, based on IEEE (registered trademark) 802.15.4., an industry organization has standardized, as a RF remote control standard, ZigBee (registered trademark) RF4CE (Radio frequency for Consumer Electronics).

For example, Japanese Patent Application Laid-open No. 2011-034294 (hereinafter, referred to as Patent Document 1) discloses a technology of a control terminal controlling an information processing apparatus such as a television receiver by using RF radio signals such as RF4CE.

Further, Japanese Patent Application Laid-open No. 2005-500772 (paragraph [0004] and the like) (hereinafter, referred to as Patent Document 2) describes that images obtained by a web camera is sent to a personal computer via a web server, the Internet, and the like such that a user is capable of remotely viewing a video took by a video camera connected to a web browser.

### SUMMARY

Meanwhile, recently, information processing apparatuses such as television receivers have extremely large number of functions. For example, some information processing apparatuses such as television receivers are capable of connecting to the Internet and accessing various web applications in the Internet. Remote control apparatuses such as RF remote controls are capable of transmitting data such as character strings to the information processing apparatuses such as television receivers. That is, the remote control apparatuses such as RF remote controls are effective control means for increasing the possibility that information processing apparatuses access and use various web applications.

However, if information processing apparatuses controlled by remote control apparatuses use image-processing web applications, existing remote control apparatuses are insufficient for that. Examples of such image-processing web applications include a web application that recognizes letters or persons' faces included in images and returns the result, and other web applications. That is, in the field of existing remote control apparatuses, no regard is even given to transmission of images to information processing apparatuses at all.

It is desirable to provide an information processing apparatus, an information processing system, and an information processing method that may improve operability in a case of passing an arbitrary image to an image-processing application, controlled by a remote control apparatus.

According to an embodiment of the present technology, there is provided an information processing apparatus, including: an image receiving unit configured to receive an image series from a remote control apparatus, the remote control apparatus including a camera unit enabling continuous-shooting, the remote control apparatus being capable of sending the image series to an information processing apparatus via a wireless medium, the image series being obtained by continuous-shooting by the camera unit; a display unit having a display screen; a display controller configured to display the received image series on the display screen in series; and an image storing unit configured to select, in response to a first control signal sent from the remote control apparatus via a wireless medium, a store-target image from the displayed image series, and to store the store-target image.

According to the information processing apparatus, the display screen is provided as a finder screen. By means of the display screen as a finder screen, a user of the remote control apparatus confirms the image series continuously shot by the camera unit of the remote control apparatus in real time. The user of the remote control apparatus confirms an image series being shot by the camera unit through the display screen of the information processing apparatus. At the same time, the user is capable of selecting a desired image to be stored. Controlled by the remote control apparatus, the stored images are appropriately provided to, for example, an application installed in the information processing apparatus, an application in the Internet, or the like. That is, according to the information processing apparatus, the operability of a series of pieces of processing may be improved. The series of pieces of processing includes capturing an image, providing the image to an application, and the like. Further, it is not necessary to mount a finder on the remote control apparatus. As a result, the remote control apparatus may be reduced in size and weight, and the power consumption of the remote control apparatus may be reduced.

Further, according to the present technology, the information processing apparatus may include a content obtaining unit configured to obtain display-dedicated content. The display controller may be configured to simultaneously display the obtained display-dedicated content and the received image series on the display screen of the display unit.

Content and a video of a photographed area in the content may be simultaneously displayed on the display screen of the information processing apparatus. Therefore, operability may be improved in a case of, for example, selecting a desired section in displayed content in terms of space and time, and storing the selected section.

The information processing apparatus may further include: an image selecting unit configured to select, in response to a second control signal sent from the remote control apparatus via a wireless medium, a processing-target image from the at least one stored image; and a processing selection unit configured to select, in response to a third control signal sent from the remote control apparatus via a wireless medium, a piece of processing to be executed on the selected processing-target image. Therefore, a processing-target image is selected from one or more stored image. Further, a piece of processing to be executed on the image is selected. Controlled by the remote control apparatus, the information processing apparatus may perform these selections.

The display controller may be configured to display, on the display screen of the display unit, a list of at least one thumbnail image of the at least one image stored in the image storing unit, and the image selecting unit may be configured to select the processing-target image in response to the second control signal from the remote control apparatus, the second control signal being a signal for selecting the processing-target image from the list of at least one thumbnail image of the at least one stored image. Therefore, operability may be improved in a case of selecting a processing-target image.

The display controller may be configured to display, on the display screen of the display unit, a list of pieces of processing to be selected, and the processing selection unit may be configured to select the piece of processing in response to the third control signal from the remote control apparatus, the third control signal being a signal for selecting the piece of processing from the list of pieces of processing to be selected. Therefore, operability may be improved in a case of selecting a piece of processing to be executed on the image.

The information processing apparatus may further include a processing execution unit configured to execute the piece of processing to process the processing-target image, the piece of processing being selected by the processing selection unit, the processing-target image being selected by the image selecting unit.

The wireless medium may be a wireless LAN. The use of a wireless LAN ensures the communication band necessary to transmit an image series, which is obtained by the camera unit, to the information processing apparatus, and to display the image series in real time.

Further, the information processing apparatus may further include a processing request unit configured to send a processing request to a server in a web, the processing request including the processing-target image selected by the image selecting unit, the server being capable of executing the piece of processing selected by the processing selection unit.

According to a second aspect of the present technology, there is provided an information processing system, including: a remote control apparatus; and an information processing apparatus capable of being controlled by the remote control apparatus via a wireless medium, wherein the remote control apparatus includes a camera unit enabling continuous-shooting, and an image sending unit configured to send an image series to the information processing apparatus via a wireless medium, the image series being obtained by continuous-shooting by the camera unit, the information processing apparatus includes a display unit having a display screen, an image receiving unit configured to receive the image series sent from the remote control apparatus, a display controller configured to display the received image series on the display screen in series, an image storing unit configured to select, in response to a first control signal sent from the remote control apparatus via a wireless medium, a store-target image from the displayed image series, and to store the store-target image, and a content obtaining unit configured to obtain display-dedicated content, and the display controller is configured to simultaneously display the obtained display-dedicated content and the received image series on the display screen of the display unit.

According to a third aspect of the present technology, there is provided an information processing method, including: sending, by a remote control apparatus, an image series to an information processing apparatus via a wireless medium, the image series being obtained by continuous-shooting by a camera unit, the information processing apparatus being a target controlled by the remote control apparatus; displaying, by a display controller of the information processing apparatus, the image series on a display screen in series, the image series being received from the remote control apparatus; selecting, by an image storing unit of the information processing apparatus, in response to a first control signal sent from the remote control apparatus via a wireless medium, a store-target image from the displayed image series, the first control signal being a signal for selecting the store-target image from the displayed image series; storing, by the image storing unit, the store-target image; obtaining, by a content obtaining unit of the information processing apparatus, display-dedicated content; and simultaneously displaying, by the display controller, the obtained display-dedicated content and the received image series on the display screen of the display unit.

According to the present technology, operability may be improved in a case of passing an arbitrary image to an image-processing application, controlled by a remote control apparatus.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing the configuration of an information processing system according to a first embodiment of the present technology;

FIG. 2 is a diagram showing the hardware configuration of an information processing apparatus of the information processing system of FIG. 1;

FIG. 3 is a front-side external view of a remote control apparatus of the information processing system of FIG. 1;

FIG. 4 is a back-side external view of the remote control apparatus of FIG. 3;

FIG. 5 is a diagram showing the hardware configuration of the remote control apparatus of FIG. 3;

FIG. 6 is a diagram showing a camera UI window of the information processing apparatus of FIG. 2;

FIG. 7 is an operation sequence diagram of the information processing system of FIG. 1;

FIG. 8 is a diagram showing an example of a primary camera UI window;

FIG. 9 is a diagram showing an example of the camera UI window in a case where part of a content display area is a subject photographed;

FIG. 10 is a diagram showing a status where a stored-image list area is updated when a camera-shot Image is stored;

FIG. 11 is a diagram showing a stored-image list area in the camera UI window;

FIG. 12 is a diagram showing the camera UI window in which an enlarged image of a stored image is displayed; and

FIG. 13 is a diagram showing an example of the camera UI window in which an application selection window is displayed.

### DETAILED DESCRIPTION OF EMBODIMENTS

Hereinafter, an embodiment of the present disclosure will be described with reference to the drawings.

### First Embodiment

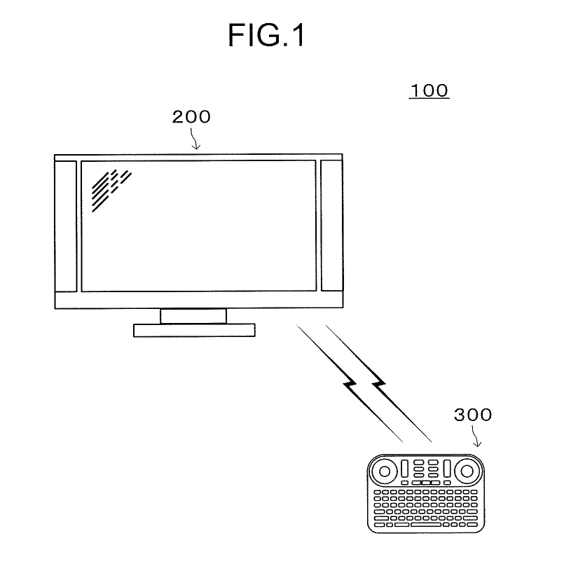

FIG. 1 is a block diagram showing the configuration of a remote control system according to a first embodiment of the present technology. As shown in FIG. 1, an information processing system 100 of this embodiment includes a control-target information processing apparatus 200 and a remote control apparatus 300. The remote control apparatus 300 is configured to remote-control the information processing apparatus 200 by using radio signals. The information processing apparatus 200 is, for example, a television receiver, a personal computer, a recorder, a player, a game machine, or the like. The information processing apparatus 200 may be any apparatus as long as it is configured to display objects on a display.

A camera module (camera unit) is mounted on the remote control apparatus 300. The camera module enables continuous-shooting, that is, the camera module is capable of continuously shooting images. Operated by a user, the camera module is capable of continuously shooting images of content displayed on a display screen of the information processing apparatus 200, and images of other arbitrary objects. The remote control apparatus 300 is capable of transmitting image-data series, which is continuously shot by the camera module, to the information processing apparatus 200 by means of a wireless LAN.

The information processing apparatus 200 is capable of, for example, receiving image-data (hereinafter referred to as “camera-shot-image”) series via the wireless LAN. The camera-shot-image series is a series of images continuously shot by the camera module of the remote control apparatus 300. Further, the information processing apparatus 200 is capable of displaying the camera-shot-image series on an external or internal display in real time. Further, in response to a first control signal sent from the remote control apparatus 300 when a camera-shot-image series is being displayed, the information processing apparatus 200 is capable of storing a camera-shot image being displayed at that time. Further, the information processing apparatus 200 is capable of passing a camera-shot image to an arbitrary application. The camera-shot image is selected from one or more stored camera-shot images in response to a second control signal sent from the remote control apparatus 300. The arbitrary application is selected in response to a third control signal sent from the remote control apparatus 300. Further, the information processing apparatus 200 is capable of causing the application to process the camera-shot image.

Recently, in the field of wireless remote control, an RF (Radio frequency) remote control using high-frequency radio waves is becoming the mainstream. Specifically, RF4CE (Radio frequency for Consumer Electronics) and the like are used. RF4CE is the international standard of RF remote controls for consumer electronics. However, the theoretical value of RF4CE communication speed is 250 Kbps. Such a speed is enough for transmitting control signals and the like, but not enough for transmitting image data in real time.

The information processing system 100 of this embodiment uses, for example, a wireless LAN in conformity with the IEEE 802.11b standard to transmit camera-shot images in real time. The nominal speed of the IEEE 802.11b standard is 11 Mbps, which is enough higher than the speed of RF4CE.

Hereinafter, the information processing system 100 of this embodiment will be described in detail.

[Configuration of Information Processing Apparatus 200]

First, the configuration of the information processing apparatus 200 will be described.

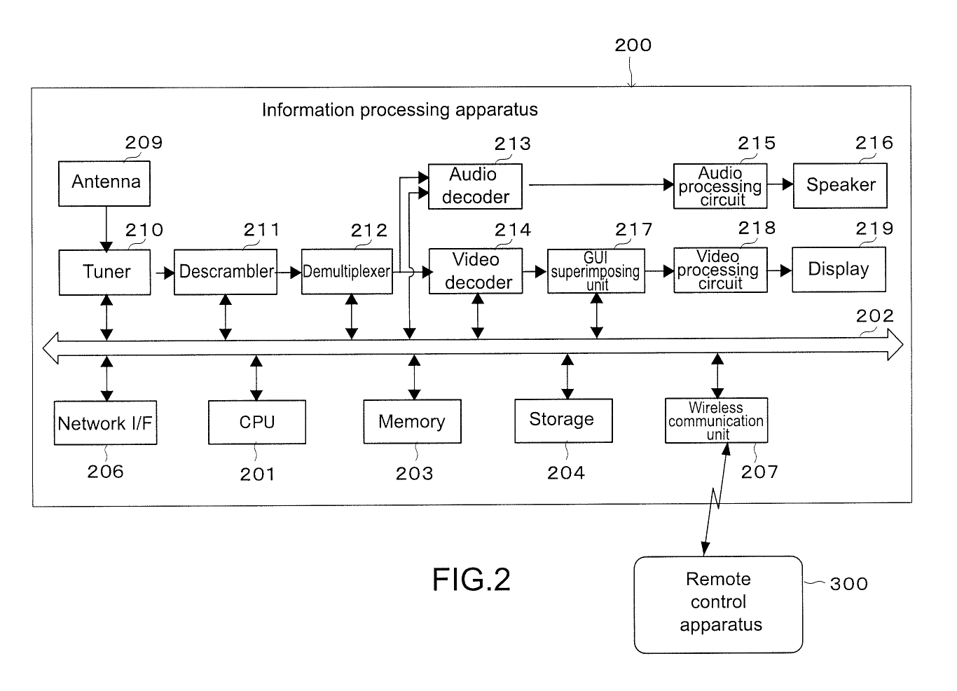

FIG. 2 is a diagram showing the hardware configuration of the information processing apparatus 200.

In this embodiment, a case where a television receiver is used as the information processing apparatus 200 will be described.

The information processing apparatus 200 includes a CPU (Central Processing Unit) 201, a bus 202, a memory 203, storage 204, a network I/F (interface) 206, and a wireless communication unit 207. The information processing apparatus 200 further includes an antenna 209, a tuner 210, a descrambler 211, a demultiplexer 212, an audio decoder 213, a video decoder 214, an audio processing circuit 215, a speaker 216, a GUI (Graphical User Interface) superimposing unit 217, a video processing circuit 218, and a display 219 (display unit).

In the information processing apparatus 200, the CPU 201 executes various kinds of processing according to programs stored in the memory 203 and the storage 204 connected via the bus 202.

The wireless communication unit 207 (image receiving unit) interactively communicates with the remote control apparatus 300 by using, for example, a wireless LAN in conformity with the IEEE 802.11b standard or the like.

The antenna 209 receives digital broadcast signals and the like, and inputs the signals in the tuner 210. The tuner 210 extracts a broadcast signal of a predetermined channel from digital broadcast signals. The tuner 210 demodulates the extracted broadcast signal to thereby obtain a transport stream of the predetermined channel, and outputs the transport stream to the descrambler 211.

The descrambler 211 descrambles the transport stream input from the tuner 210 by using a descrambler key. The descrambler key is prerecorded in a predetermined integrated circuit card (not shown) mounted in the information processing apparatus 200. The descrambler 211 outputs the descrambled transport stream to the demultiplexer 212.

The demultiplexer 212 demultiplexes audio data and video data from the descrambled transport stream input from the descrambler 211. The demultiplexer 212 outputs the demultiplexed audio data to the audio decoder 213, and outputs the demultiplexed video data to the video decoder 214.

The audio decoder 213 decodes the audio data input from the demultiplexer 212, and outputs the obtained audio data to the audio processing circuit 215.

The audio processing circuit 215 D/A (Digital/Analog) converts and amplifies the audio data input from the audio decoder 213, and performs other processing. The audio processing circuit 215 outputs the obtained audio signal to the speaker 216.

The video decoder 214 decodes the video data input from the demultiplexer 212, and outputs the obtained video data to the GUI superimposing unit 217.

The GUI superimposing unit 217 superimposes graphic data such as OSD (On Screen Display) on the video data input from the video decoder 214, and outputs the video data to the video processing circuit 218.

The video processing circuit 218 performs predetermined image processing, D/A (Digital/Analog) converting processing, and the like on the video data input from the GUI superimposing unit 217, and output the obtained video signal to the display 219.

Further, the CPU 201 receives digital broadcast signals in response to a recording control signal from the remote control apparatus 300 or based on information on timer recording set in the memory 203. Further, the CPU 201 obtains a transport stream of a predetermined channel, and stores the transport stream in the storage 204 as video/audio data of a broadcast program.

As described above, the information processing apparatus 200 is capable of receiving digital broadcast signals, outputting the broadcast program from the display 219 and the speaker 216 such that a user may watch and listen to the broadcast program, recording the broadcast program in the storage 204, and the like. Further, the CPU 201 is also capable of accessing the Internet via the network I/F 206, and displaying the obtained web pages on the display 219.

Various application programs such as a camera-shooting application, a web browser, a timer-recording application, and the like are stored in the memory 203 or the storage 204.

[Configuration of Remote Control Apparatus 300]

Next, the configuration of the remote control apparatus 300 will be described.

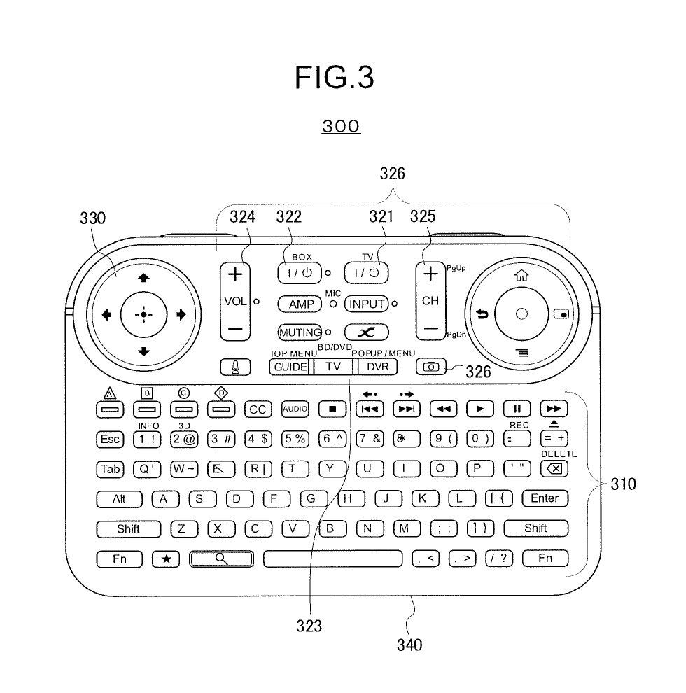

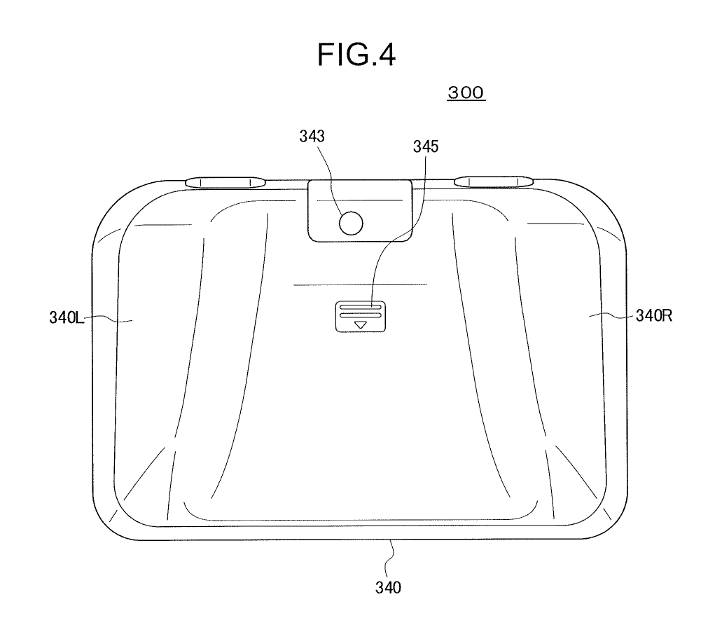

FIG. 3 and FIG. 4 are external views of the remote control apparatus 300.

As shown in FIG. 3, a keyboard 310, remote control keys 320, a pointing device 330, and the like are provided on the front surface of the remote control apparatus 300. The keyboard 310 includes a plurality of keys for inputting letters and the like. The remote control keys 320 include a main power source button 321 for the television receiver, a main power source button 322 for a set-top box, operation buttons 323 for BD (blu-ray)/DVD (Digital Versatile Disc), an audio volume correction button 324, a channel switch button 325, a camera button 326, and the like.

As shown in FIG. 4, a housing 340 of the remote control apparatus 300 has left and right swell portions. Because of this shape, a user may hold the left and right swell portions with his left and right hands without difficulty. Such left and right swell portions serve as a pair of left and right grip portions 341L, 341R. Further, a lens hole 343 of a camera module 303 is provided on the midpoint of the pair of left and right grip portions 341L, 341R on the back surface of the housing 340. Further, a sliding cover 345 for attaching/detaching a battery is provided on the midpoint of the pair of left and right grip portions 341L, 341R on the back surface of the housing 340. The battery is attached on a position, which emergences when the sliding cover 345 is open.

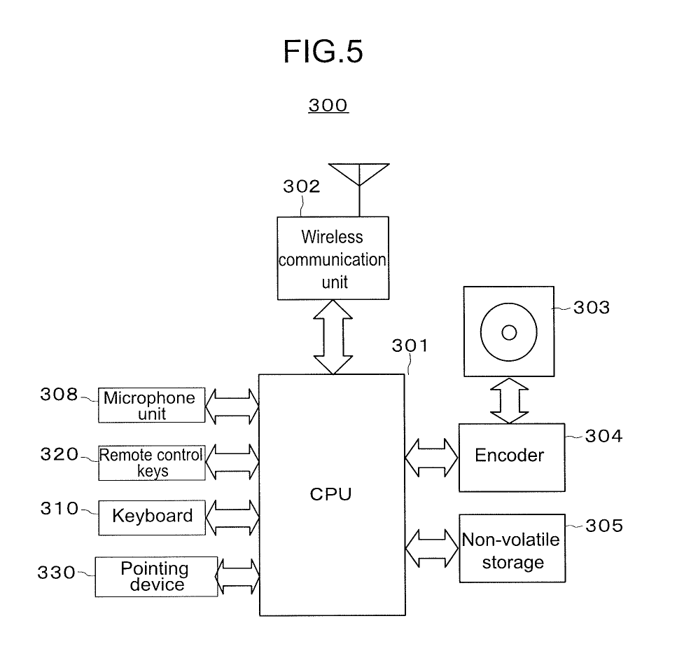

FIG. 5 is a diagram showing the hardware configuration of the remote control apparatus 300.

The remote control apparatus 300 includes a CPU 301, a wireless communication unit 302, the camera module 303, an encoder 304, non-volatile storage 305, the remote control keys 320, and the keyboard 310. The remote control apparatus 300 further includes the pointing device 330, a microphone unit 308, and the like.

The CPU 301 entirely controls the respective blocks included in the remote control apparatus 300, performs various kinds of arithmetic processing, and controls data transfer between the respective blocks.

The wireless communication unit 302 interactively communicates with the information processing apparatus 200. For example, a wireless LAN in conformity with the IEEE 802.11b standard or the like may be used.

The camera module 303 is used to take images to be transmitted to the information processing apparatus 200. The camera module 303 includes an image sensor such as a CMOS (Complementary Metal Oxide Semiconductor) image sensor, an A/D converter A/D-converting the output from the image sensor, and the like.

The encoder 304 encodes the images took by the camera module 303 to thereby obtain typical encoded data such as JPEG (Joint Photographical Experts Group) data.

The non-volatile storage 305 stores the encoded image data and the like.

The pointing device 330 inputs coordinate data and the like. For example, the pointing device 330 inputs pointing-cursor operations on the display of the information processing apparatus 200. The pointing device 330 is an optical mouse or the like.

The microphone unit 308 mainly collects user's voices. The microphone unit 308 captures sounds, converts the sounds to electric signals, and supplies the electric signals to the CPU 301.

### [Camera UI Window]

Next, a camera UI (User Interface) window will be described. The camera UI window is displayed on the display 219 of the information processing apparatus 200.

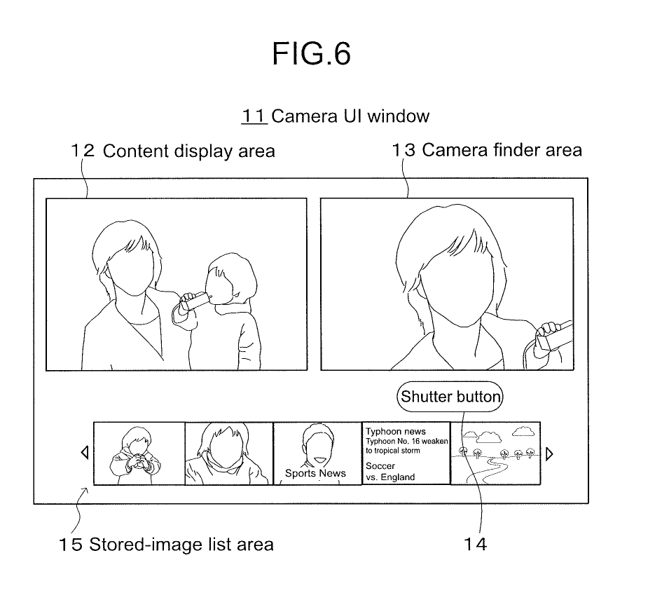

FIG. 6 is a diagram showing an example of the camera UI window.

A camera UI window 11 includes a content display area 12, a camera finder area 13, a shutter button 14, a stored-image list area 15, and the like.

The content display area 12 and the camera finder area 13 are arranged side by side. The shutter button 14 is provided in vicinity of the lower portion of the camera finder area 13. The stored-image list area 15 is provided on the lower portion of the camera UI window 11.

In the content display area 12, content such as digital broadcasting and web pages received by the information processing apparatus 200 is displayed. The information processing apparatus 200 is configured to receive television broadcast content via terrestrial digital broadcasting, wire broadcasting, satellite broadcasting, and the like. The information processing apparatus 200 (content obtaining unit) is configured to obtain web content such as web pages and images (still images, moving images) in the Internet. That is, television broadcast content, web content, and the like selected by a user is displayed in the content display area 12.

In the camera finder area 13, a camera-shot-image series, which is continuously shot by the camera module 303 of the remote control apparatus 300, is displayed.

The shutter button 14 is a GUI element and accepts an instruction to select, by a user, a camera-shot image of a certain timing to be stored. The camera-shot image to be stored is one image in the camera-shot-image series displayed in the camera finder area 13. The shutter button 14 is operated in the following manner. For example, the pointing device 330 of the remote control apparatus 300 is operated such that a pointing cursor is moved, the pointing cursor is set on the shutter button 14, and an enter key is operated. Alternatively, the camera button 326 is operated.

The CPU 201 of the information processing apparatus 200 recognizes that the shutter button 14 is operated, based on a control signal (first control signal) from the remote control apparatus 300. Then, the CPU 201 stores the camera-shot image, which is displayed in the camera finder area 13 at that time, in the storage 204. At this time, the CPU 201 generates a thumbnail image having a reduced resolution. The CPU 201 stores the thumbnail image in the storage 204 in association with the camera-shot image. The thumbnail image is to be displayed in the stored-image list area 15.

In the stored-image list area 15, thumbnail images of camera-shot images, which are stored in the storage 204, are displayed in series in the predetermined order. An example of the predetermined order is the order of store date and time.

[Operation of the Information Processing System 100]

Next, operation of the information processing system 100 will be described.

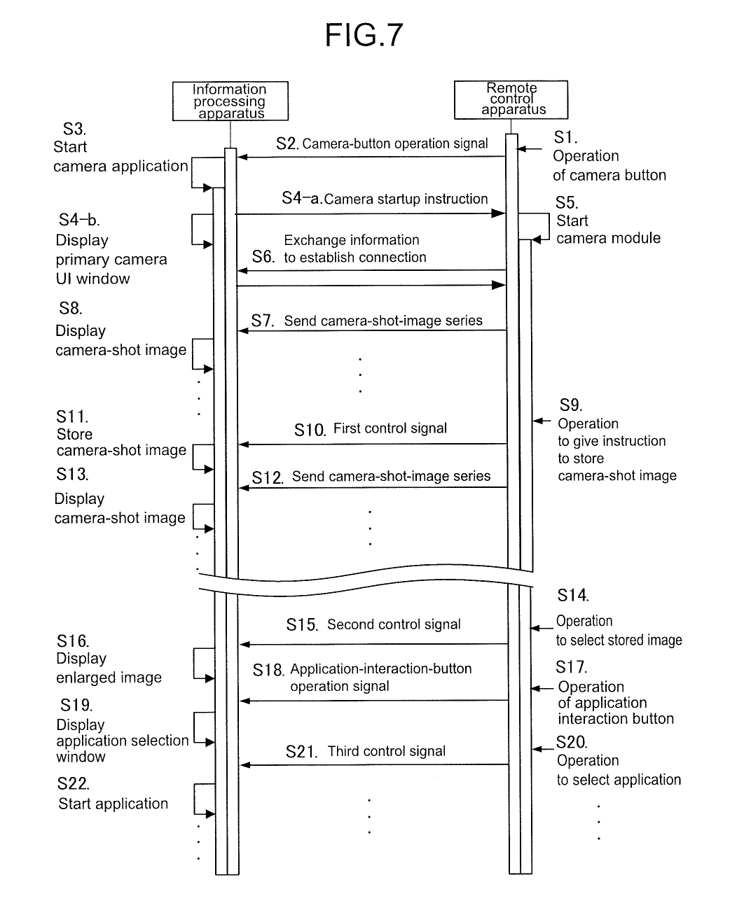

FIG. 7 is a sequence diagram showing operation of the information processing system 100. Specifically, the operation relates to transmitting a camera-shot-image series from the remote control apparatus 300 to the information processing apparatus 200, storing the camera-shot-image series, passing the camera-shot-image series to an application, and the like.

The camera button 326 (refer to FIG. 3) of the remote control apparatus 300 is operated by a user (Step S1). Then, the CPU 301 detects that. The CPU 301 sends a camera-button operation signal to the information processing apparatus 200 by means of the wireless communication unit 302 (Step S2). The camera-button operation signal indicates that the camera button 326 is operated.

The CPU 201 of the information processing apparatus 200 receives the camera-button operation signal via the wireless communication unit 207. Then, the CPU 201 starts a camera-shooting application (Step S3). According to the procedure provided by the camera-shooting application, first, the CPU 201 sends a camera startup instruction to the remote control apparatus 300 by means of the wireless communication unit 207 (Step S4-a). The camera startup instruction is an instruction to start the camera module 303 of the remote control apparatus 300. In addition, the CPU 201 displays the camera UI window on the display 219 (Step S4-b).

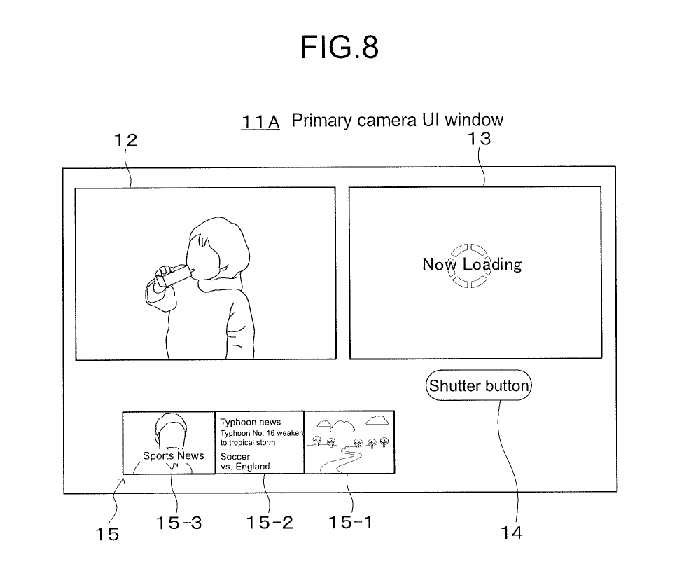

FIG. 8 is a diagram showing an example of a primary camera UI window 11A. In the camera finder area 13, an icon and a character string are displayed until a camera-shot image is transmitted from the camera module 303 of the remote control apparatus 300. The icon and the character string indicate a wait status for transmission of a camera-shot image. In the stored-image list area 15, thumbnail images 15-1, 15-2, 15-3 are displayed in the order of store date and time. The thumbnail images 15-1, 15-2, 15-3 are thumbnail images of camera-shot images previously stored.

The CPU 301 of the remote control apparatus 300 receives the camera startup instruction via the wireless communication unit 302. Then, the CPU 301 starts the camera module 303 (Step S5). After the startup, the camera module 303 exchanges information with the camera-shooting application of the information processing apparatus 200 (Step S6). The information exchanged here is information necessary to establish a connection (for example, port number, IP address, etc.). The connection status between the camera module 303 of the remote control apparatus 300 and the camera-shooting application of the information processing apparatus 200 is established. Then, the camera module 303 generates still-image series (camera-shot-image series) from imaging signals obtained by the image sensor of the camera module 303. The still-image series includes a plurality of still images took at regular time intervals.

The format of still images is, for example, JPEG (Joint Photographic Experts Group) or the like. The wireless communication unit 302 sends the camera-shot-image series, which is generated by the camera module 303, to the information processing apparatus 200 (Step S7).

The CPU 201 (display controller) of the information processing apparatus 200 receives the camera-shot-image series via the wireless communication unit 207. Then, the video decoder 214 decodes, in series, the camera-shot-image series. The CPU 201 continuously displays the decoded camera-shot-image series in the camera finder area 13 on the screen of the display 219 (Step S8). In such a manner, the camera-shot-image series is displayed in the camera finder area 13 as a moving image. As a result, a user of the remote control apparatus 300 may confirm, in real time, content, which is took by the camera module 303, on the camera finder area 13 on the display 219 of the information processing apparatus 200. That is, according to this embodiment, part of the display space of the display 219 of the information processing apparatus 200 may be used as a finder for a camera-shot image, which is took by the camera module 303 of the remote control apparatus 300.

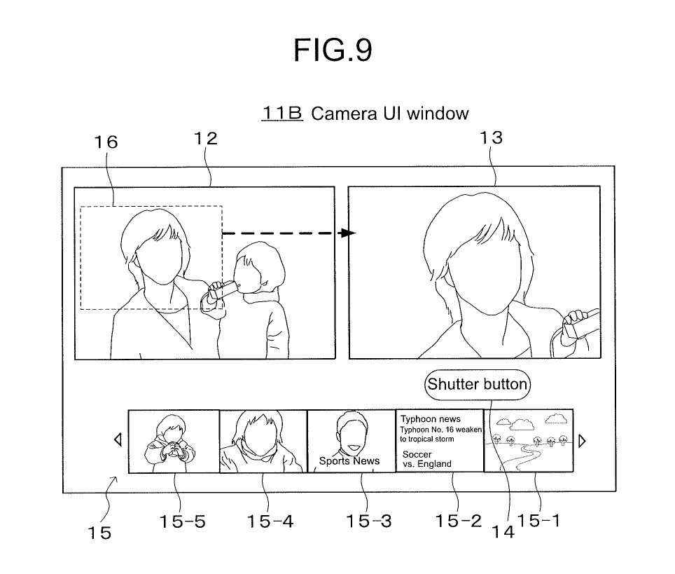

FIG. 9 is a diagram showing an example of a camera UI window 11B. In FIG. 9, the photographed subject is part of the content display area 12. Here, a dotted rectangular area, which is denoted by reference numeral 16, is a photographed area took by the camera module 303. The video of the photographed area 16 in the content display area 12, which is took by the camera module 303, is displayed in the camera finder area 13 in real time. That is, as content displayed in the content display area 12 changes and as the photographed area took by the camera module 303 moves, content displayed in the camera finder area 13 also changes in real time.

As shown in FIG. 9, a camera-shot image is displayed in the camera finder area 13. In this state, operated by a user, the remote control apparatus 300 is capable of giving an instruction, which instructs to store a camera-shot image being displayed in the camera finder area 13, to the camera-shooting application of the information processing apparatus 200 (Steps S9, S10). The storing instruction is input by, for example, operating the pointing device 330 of the remote control apparatus 300. Specifically, the storing instruction is input by moving the pointing cursor, setting the pointing cursor on the shutter button 14, and operating the enter key. Alternatively, the storing instruction is input by operating the camera button 326. In response to the storing operation, the CPU 301 of the remote control apparatus 300 sends a first control signal to the information processing apparatus 200 by means of the wireless communication unit 302.

The CPU 201 (image storing unit) of the information processing apparatus 200 receives the first control signal from the remote control apparatus 300 by means of the wireless communication unit 207. Then, the CPU 201 stores a camera-shot image being displayed in the camera finder area 13 in the storage 204 as a stored image (Step S11). When storing the camera-shot image, the CPU 201 generates a thumbnail image from the camera-shot image. The CPU 201 stores the thumbnail image in the storage 204 in association with the stored image. The thumbnail image generated from the camera-shot image is added to the stored-image list, and displayed in the stored-image list area 15. After that, also, a camera-shot-image series, which is generated by the camera module 303, is sent to the information processing apparatus 200 (Step S12). The camera-shot-image series is displayed in the camera finder area 13 on the screen of the display 219 of the information processing apparatus 200 (Step S13).

Note that the number of images displayed in the stored-image list area 15 at a time is limited, because of the limitation of the display space. Because of this, thumbnail images of the maximum number of stored images, out of all the stored images sorted by the preset condition, are displayed in the stored-image list area 15.

For example, thumbnail images of stored images, each having resent store date and time, are preferentially displayed. A user operates, for example, a left key and a right key of the pointing device 330 of the remote control apparatus 300. As a result, the stored-image series, which is displayed in the stored-image list area 15, is wholly shifted to right and left in all the stored images.

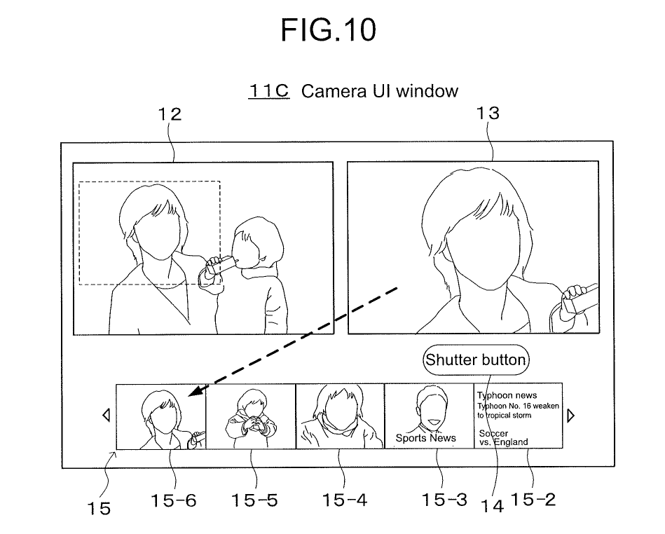

FIG. 10 is a diagram showing an example of a camera UI window 11C when a camera-shot image is stored. The camera-shot image being displayed in the camera finder area 13 is stored. In addition, a thumbnail image 15-6 of the camera-shot image is added to the end of the stored-image list area 15. The respective stored-image series 15-2, 15-3, 15-4, 15-5, which have been displayed, are shifted in the right direction by one image. Note that, this example shows a case where the thumbnail images each having the recent store date and time are displayed on the left side, and thumbnail images each having earlier store date and time are displayed on the right side.

A user of the remote control apparatus 300 is capable of selecting a thumbnail image of an arbitrary stored image from the stored-image list displayed in the stored-image list area 15. An arbitrary application processes the selected stored image.

Next, operations in this case will be described.

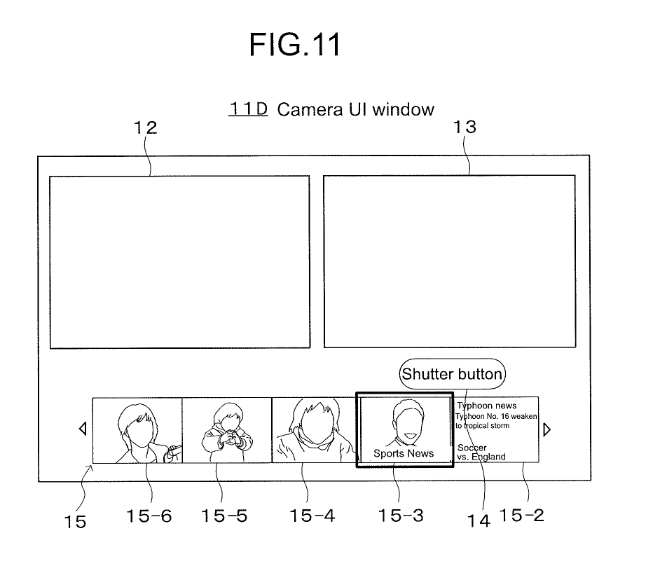

As shown in FIG. 11, any one thumbnail image is highlighted in the stored-image list area 15 on a camera UI window 11D. A user operates, for example, the left key and the right key of the pointing device 330 of the remote control apparatus 300. As a result, the highlight moves in the right and left directions. Further, the user operates the right key once in a state where the right-end thumbnail image is highlighted in the stored-image list area 15. As a result, the thumbnail image series in the stored-image list area 15 wholly shifts in the right direction by one image. At the same time, the highlight moves, and the stored image, which is newly displayed because of the shift, is highlighted. Similarly, the user operates the left key once in a state where the left-end thumbnail image is highlighted in the stored-image list area 15. As a result, the thumbnail image series in the stored-image list area 15 wholly shifts in the left direction by one image. At the same time, the highlight moves, and the thumbnail image, which is newly displayed because of the shift, is highlighted.

Here, in a state where an arbitrary thumbnail image (for example, 15-3) is highlighted, the enter key of the pointing device 330, for example, of the remote control apparatus 300 is operated (Step S14). Then, the CPU 301 of the remote control apparatus 300 controls to send a second control signal to the information processing apparatus 200 by means of the wireless communication unit 302 (Step S15). The second control signal is a signal to select the stored image, which corresponds to the thumbnail image 15-3 being highlighted, as an image to be given to an arbitrary application.

The CPU 201 of the information processing apparatus 200 receives the second control signal from the remote control apparatus 300 by means of the wireless communication unit 207. Then, the CPU 201 displays an image, which is obtained by enlarging the stored image corresponding to the thumbnail image being highlighted (Step S16).

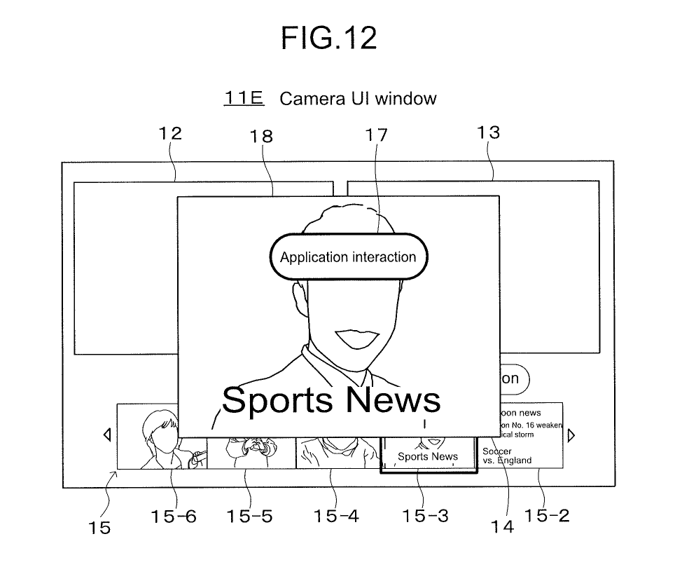

FIG. 12 is a diagram showing a camera UI window 11E in which an enlarged image 18 of a stored image is displayed. The enlarged image 18 window includes an application interaction button 17. The application interaction button 17 is operated by, for example, the pointing device 330 of the remote control apparatus 300 or the like (Step S17). Then, the CPU 301 of the remote control apparatus 300 controls to send, by the wireless communication unit 302, an application-interaction-button operation signal to the information processing apparatus 200 (Step S18).

The CPU 201 of the information processing apparatus 200 receives the application-interaction-button operation signal by means of the wireless communication unit 207. Then, the CPU 201 displays an application selection window (Step S19). The application selection window is used to select an application capable of interacting with the camera-shooting application.

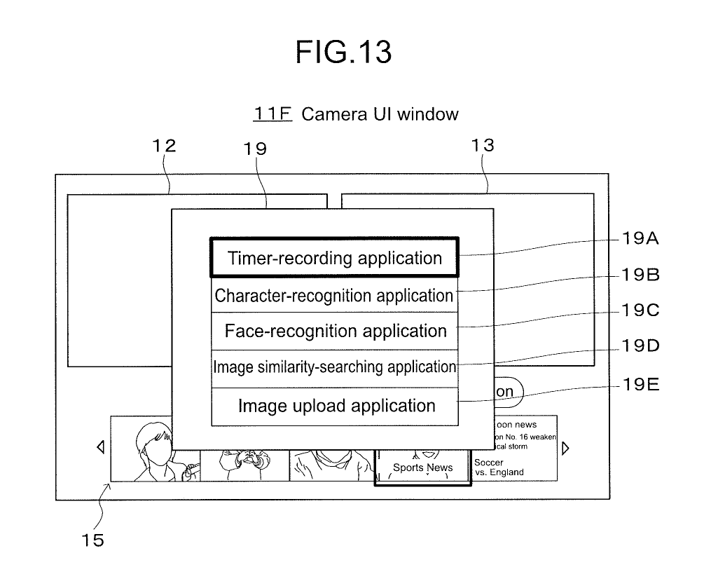

FIG. 13 is a diagram showing an example of a camera UI window 11F in which an application selection window 19 is displayed. Examples of the application capable of interacting with the camera-shooting application include an application executed by the information processing apparatus 200, a web application, and the like. The information processing apparatus 200 accesses the Internet, and is then capable of using the web application. More specifically, examples of the application capable of interacting with the camera-shooting application include a timer-recording application, a character-recognition application, a face-recognition application, an image similarity-searching application, an image upload application, and the like. The timer-recording application performs timer recording of a broadcast program. The character-recognition application recognizes character strings and the like in an image. The face-recognition application extracts a face section in an image and searches for a person. The image similarity-searching application searches image similarities and the like. The image upload application uploads an image on a server, which provides an image sharing service. Note that some applications in this application group may interact with each other. GUI elements 19A-19E for the above-mentioned respective applications are displayed in the application selection window 19.

A user of the remote control apparatus 300 may feely select an application, which processes a selected stored image, in the application selection window 19 (Step S20).

An arbitrary application is selected in the application selection window 19 by operating the pointing device 330 of the remote control apparatus 300 as follows, for example. A pointing cursor is moved, the pointing cursor is set on the GUI element of a target application, and the enter key is operated.

The CPU 301 of the remote control apparatus 300 controls to send, by means of the wireless communication unit 302, a third control signal to the information processing apparatus 200. The third control signal corresponds to the selection operation of an arbitrary GUI element in the application selection window 19 (Step S21).

A timer-recording application 19A is selected in the application selection window 19. Operations thereafter will be described.

The CPU 201 of the information processing apparatus 200 receives a third control signal from the remote control apparatus 300 by means of the wireless communication unit 207. The third control signal corresponds to the selection operation of the timer-recording application 19A. Then, the CPU 201 starts the timer-recording application (Step S22).

According to the procedure provided by the timer-recording application, the CPU 201 of the information processing apparatus 200 retrieves a processing-target stored image from the storage 204. Next, the CPU 201 sends a processing request to a server, which is capable of executing the character-recognition application. The processing request includes the retrieved stored image. According to the procedure provided by the character-recognition application, the server recognizes characters in the image, which is included in the processing request from the information processing apparatus 200. Further, the server returns the result to the information processing apparatus 200. For example, in the example of FIG. 12, the character string “Sports News”, which is a program title and is included in the stored image, is obtained as the recognition result.

Note that, in a case where the character-recognition application is installed in the information processing apparatus 200, the CPU 201 calls the character-recognition application, and passes the character-recognition application an image.

The CPU 201 of the information processing apparatus 200 receives the character string as the recognition result. Next, according to the procedure provided by the timer-recording application, the CPU 201 searches EPG (Interactive Program Guide) data for the character string. That is, the CPU 201 attempts to retrieve a program title including the character string, and to find a program corresponding to the title. If an appropriate program is found, the CPU 201 of the information processing apparatus 200 extracts information, which is necessary for timer-recording of the program, from the EPG data. Such information includes, for example, the channel, broadcasting hours (start time/ending time), and the like. Further, the CPU 201 outputs a timer recording request, which includes the information necessary for timer-recording, to a recorder or the like. For example, the recorder is externally connected to the information processing apparatus 200. Further, if the information processing apparatus 200 includes an internal recorder, the CPU 201 sets timer recording on the recorder.

In the above, an image including a character string of a program title is passed to a character-recognition application. Alternatively, an image including a person's face may be passed to a face-recognition application. In this case, a server executing the face-recognition application determines the person's name based on a famous person's face included in a shot image.

Further, the server returns the person's name to the information processing apparatus 200. The CPU 201 of the information processing apparatus 200 searches EPG data for the person's name. That is, the CPU 201 retrieves the person's name, which is a cast's name or a producer's name, and finds a program corresponding to the person's name. Then, the CPU 201 executes timer recording.

As described above, according to the information processing system 100 of this embodiment, content and a video of a photographed area in the content are simultaneously displayed on the screen of the display 219 of the information processing apparatus 200. Therefore, operability may be improved in a case of, for example, selecting a desired section in displayed content in terms of space and time, and storing the selected section.

In the information processing system 100 of this embodiment, it is needless to say that a subject to be photographed by the camera module 303 of the remote control apparatus 300 may be a subject other than content displayed on the display 219 of the information processing apparatus 200. In such a use, the screen of the display 219 may be used as a finder. So, the hardware configuration of the entire system may be simpler than the hardware configuration of the remote control apparatus 300 additionally having a finder. This is an advantage of this embodiment.

Further, according to the information processing system 100 of this embodiment, a processing-target image is selected from stored images. Further, an application, which processes the selected stored image, is selected. Controlled by the remote control apparatus 300, the information processing apparatus 200 performs these selections seamlessly. In this case, when selecting a processing-target image from stored images, a user may refer to thumbnail images for the respective stored images, which are displayed on the stored-image list area 15 in the camera UI window 11. Therefore, a user may find a desired stored image, which is an application processing target, without difficulty.

Note that, the present technology may employ the following configurations.

(1) An information processing apparatus, comprising:

an image receiving unit configured to receive an image series from a remote control apparatus, the remote control apparatus including a camera unit enabling continuous-shooting, the remote control apparatus being capable of sending the image series to an information processing apparatus via a wireless medium, the image series being obtained by continuous-shooting by the camera unit;

a display unit having a display screen;

a display controller configured to display the received image series on the display screen in series;

an image storing unit configured
to select, in response to a first control signal sent from the remote control apparatus via a wireless medium, a store-target image from the displayed image series, and
to store the store-target image; and

a content obtaining unit configured to obtain display-dedicated content, wherein

the display controller is configured to simultaneously display the obtained display-dedicated content and the received image series on the display screen of the display unit.

(2) The information processing apparatus according to (1), further comprising:

an image selecting unit configured to select, in response to a second control signal sent from the remote control apparatus via a wireless medium, a processing-target image from the at least one stored image; and

a processing selection unit configured to select, in response to a third control signal sent from the remote control apparatus via a wireless medium, a piece of processing to be executed on the selected processing-target image.

(3) The information processing apparatus according to (1) or (2), wherein

the display controller is configured to display, on the display screen of the display unit, a list of at least one thumbnail image of the at least one image stored in the image storing unit, and

the image selecting unit is configured to select the processing-target image in response to the second control signal from the remote control apparatus, the second control signal being a signal for selecting the processing-target image from the list of at least one thumbnail image of the at least one stored image.

(4) The information processing apparatus according to (3), wherein

the display controller is configured to display, on the display screen of the display unit, a list of pieces of processing to be selected, and

the processing selection unit is configured to select the piece of processing in response to the third control signal from the remote control apparatus, the third control signal being a signal for selecting the piece of processing from the list of pieces of processing to be selected.

(5) The information processing apparatus according to (3) or (4), further comprising:

a processing execution unit configured to execute the piece of processing to process the processing-target image, the piece of processing being selected by the processing selection unit, the processing-target image being selected by the image selecting unit.

(6) The information processing apparatus according to any one of (1) to (5), wherein

the wireless medium is a wireless LAN.

(7) The information processing apparatus according to any one of (1) to (6), further comprising:

a processing request unit configured to send a processing request to a server in a web, the processing request including the processing-target image selected by the image selecting unit, the server being capable of executing the piece of processing selected by the processing selection unit.

The present technology is not limited to the above-described embodiment, and may be variously modified within the scope of the technological thought of the present technology.

The present disclosure contains subject matter related to that disclosed in Japanese Priority Patent Application JP 2011-184001 filed in the Japan Patent Office on Aug. 25, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
an image receiving unit configured to receive an image series from a remote control apparatus, the remote control apparatus including a camera unit enabling continuous-shooting, the remote control apparatus being capable of sending the image series to an information processing apparatus via a wireless medium, the image series being obtained by continuous-shooting by the camera unit;
a display unit having a display screen;
a display controller configured to display the received image series on the display screen in series;
an image storing unit configured
to select, in response to a first control signal sent from the remote control apparatus via a wireless medium, a store-target image from the displayed image series, and
to store the store-target image; and
a content obtaining unit configured to obtain display-dedicated content, wherein
the display controller is configured to simultaneously display the obtained display-dedicated content and the received image series on the display screen of the display unit.

2. The information processing apparatus according to claim 1, further comprising:
an image selecting unit configured to select, in response to a second control signal sent from the remote control apparatus via a wireless medium, a processing-target image from the at least one stored image; and
a processing selection unit configured to select, in response to a third control signal sent from the remote control apparatus via a wireless medium, a piece of processing to be executed on the selected processing-target image.

3. The information processing apparatus according to claim 2, wherein
the display controller is configured to display, on the display screen of the display unit, a list of at least one thumbnail image of the at least one image stored in the image storing unit, and
the image selecting unit is configured to select the processing-target image in response to the second control signal from the remote control apparatus, the second control signal being a signal for selecting the processing-target image from the list of at least one thumbnail image of the at least one stored image.

4. The information processing apparatus according to claim 3, wherein
the display controller is configured to display, on the display screen of the display unit, a list of pieces of processing to be selected, and
the processing selection unit is configured to select the piece of processing in response to the third control signal from the remote control apparatus, the third control signal being a signal for selecting the piece of processing from the list of pieces of processing to be selected.

5. The information processing apparatus according to claim 4, further comprising:
a processing execution unit configured to execute the piece of processing to process the processing-target image, the piece of processing being selected by the processing selection unit, the processing-target image being selected by the image selecting unit.

6. The information processing apparatus according to claim 5, wherein
the wireless medium is a wireless LAN.

7. The information processing apparatus according to claim 4, further comprising:
a processing request unit configured to send a processing request to a server in a web, the processing request including the processing-target image selected by the image selecting unit, the server being capable of executing the piece of processing selected by the processing selection unit.

8. An information processing system, comprising:
a remote control apparatus; and
an information processing apparatus capable of being controlled by the remote control apparatus via a wireless medium, wherein
the remote control apparatus includes
a camera unit enabling continuous-shooting, and
an image sending unit configured to send an image series to the information processing apparatus via a wireless medium, the image series being obtained by continuous-shooting by the camera unit,
the information processing apparatus includes
a display unit having a display screen,
an image receiving unit configured to receive the image series sent from the remote control apparatus,
a display controller configured to display the received image series on the display screen in series,
an image storing unit configured
to select, in response to a first control signal sent from the remote control apparatus via a wireless medium, a store-target image from the displayed image series, and
to store the store-target image, and
a content obtaining unit configured to obtain display-dedicated content, and
the display controller is configured to simultaneously display the obtained display-dedicated content and the received image series on the display screen of the display unit.

9. An information processing method, comprising:
sending, by a remote control apparatus, an image series to an information processing apparatus via a wireless medium, the image series being obtained by continuous-shooting by a camera unit, the information processing apparatus being a target controlled by the remote control apparatus;
displaying, by a display controller of the information processing apparatus, the image series on a display screen in series, the image series being received from the remote control apparatus;
selecting, by an image storing unit of the information processing apparatus, in response to a first control signal sent from the remote control apparatus via a wireless medium, a store-target image from the displayed image series, the first control signal being a signal for selecting the store-target image from the displayed image series;
storing, by the image storing unit, the store-target image;
obtaining, by a content obtaining unit of the information processing apparatus, display-dedicated content; and
simultaneously displaying, by the display controller, the obtained display-dedicated content and the received image series on the display screen of the display unit.
